(19) United States
(12) Patent Application Publication
(10) Pub. No.: US 2017/0098873 A1
(43) Pub. Date: Apr. 6, 2017

(54) ELECTRIC STORAGE MODULE AND ELECTRIC STORAGE UNIT

(71) Applicant: TAIYO YUDEN CO., LTD., Tokyo (JP)

(72) Inventors: Takayuki TSUCHIYA, Takasaki-shi (JP); Shinji ISHII, Takasaki-shi (JP)

(21) Appl. No.: 15/277,851

(22) Filed: Sep. 27, 2016

(30) Foreign Application Priority Data
Oct. 1, 2015 (JP) 2015-195932

(51) Int. Cl. H01M 10/613; H01M 10/6568; H01M 10/6562; H01G 11/54; H01G 11/78; H01G 11/74; H01G 11/18; H01M 10/0525; H01M 2/20

(52) U.S. Cl. CPC H01M 10/613; H01M 10/0525; H01M 10/6568; H01M 10/6562; H01M 2/202; H01G 11/78; H01G 11/74; H01G 11/18; H01G 11/54

(57) ABSTRACT

An electric storage module includes a first electric storage cell, second electric storage cell, frame, first plate, and second plate. The first/second electric storage cell has a first/second electric storage element having positive and negative electrodes, as well as a first/second covering film that, together with electrolyte, seals the first/second electric storage element, wherein the second electric storage cell is stacked with the first electric storage cell either directly or indirectly. The frame forms a housing space in which the first electric storage cell and second electric storage cell are housed. The first/second plate is made of metal and attached to the frame, and the second plate together with the first plate, sandwiches the first electric storage cell and second electric storage cell.

### BACKGROUND

Field of the Invention

The present invention relates to an electric storage module with built-in electric storage cells, as well as an electric storage unit comprising multiple electric storage modules that have been unitized.

Description of the Related Art

Electric storage modules equipped with batteries, capacitors, or other electric storage cells are widely used, and it is also common practice to connect and unitize multiple electric storage modules to increase the electric storage capacity (refer to Patent Literatures 1 and 2, for example).

On the other hand, unitizing multiple electric storage modules presents a problem of heat generation due to electric storage cells. Particularly when there is a large temperature difference between an electric storage module placed inside and an electric storage module placed on the outer periphery, a problem of non-uniform longevity of electric storage modules, etc., will occur. Increasing the intervals between the unitized electric storage modules solves the problem of heat generation, but it increases the unit size, which is not desirable from the viewpoint of design flexibility.

### Background Art Literatures

[Patent Literature 1] Japanese Patent Laid-open No. 2013-201136

[Patent Literature 2] Japanese Patent Laid-open No. 2014-192091

### SUMMARY

In light of the aforementioned situations, an object of the present invention is to provide an electric storage module suitable for unitization and demonstrating excellent heat discharge property, as well as an electric storage unit.

To achieve the aforementioned object, the electric storage module pertaining to one mode of the present invention comprises a first electric storage cell, second electric storage cell, frame, first plate, and second plate.

The first electric storage cell has a first electric storage element having positive and negative electrodes, as well as a first covering film that, together with electrolyte, seals the first electric storage element.

The second electric storage cell has a second electric storage element having positive and negative electrodes, as well as a second covering film that, together with electrolyte, seals the second electric storage element, and wherein the second electric storage cell is stacked with the first electric storage cell either directly or indirectly. The word “stacked directly” refers to arranged in a stack (typically aligned in a stacking direction) without any intervening material or member and in a manner physically contacting each other in some embodiments. The word “stacked indirectly” refers to arranged in a stack (typically aligned in a stacking direction) with an intervening material or member (e.g., a heat discharging member) and in a manner physically contacting each other via the intervening material or member in some embodiments.

The frame forms a housing space in which the first electric storage cell and second electric storage cell are housed.

The first plate is made of metal and attached to the frame.

The second plate is made of metal and attached to the frame, and together with the first plate, sandwiches the first electric storage cell and second electric storage cell typically in a manner pressing the first and second electric storage cells.

According to this constitution, the heat generated by the first electric storage cell and second electric storage cell is transmitted to the first plate and second plate and discharged from the first plate and second plate, which allows the electric storage module to demonstrate high heat discharge effect. Also when electric storage modules are unitized, the heat generated by the first electric storage cell and second electric storage cell of one electric storage module is transmitted to an adjacent electric storage module via the first plate and second plate, thereby equalizing the temperature distribution of each electric storage module. In addition, the first electric storage cell and second electric storage cell are stacked on top of each other either directly or indirectly, which makes it possible to reduce the temperature variation in each electric storage cell.

The electric storage module may further comprise a first heat transmission member which is placed between the first electric storage cell and first plate and contacts the first electric storage cell and first plate, as well as a second heat transmission member which is placed between the second electric storage cell and second plate and contacts the second electric storage cell and second plate.

According to this constitution, heat conductivity between the first electric storage cell and first plate, and between the second electric storage cell and second plate, can be improved.

The frame has a positive electrode terminal and negative electrode terminal that are electrically connected to the first electric storage cell and second electric storage cell, and the positive electrode terminal and negative electrode terminal may be placed symmetrically on one face of the frame.

According to this constitution, the positions of the positive electrode terminal and negative electrode terminal can be swapped by changing the orientation of the electric storage module at the time of unitization, thereby allowing electric storage modules to be unitized according to various embodiments.

To achieve the aforementioned object, the electric storage unit pertaining to one mode of the present invention is constituted by multiple electric storage modules that are attached together. The electric storage modules each comprise a first electric storage cell, second electric storage cell, frame, first plate, and second plate.

The first electric storage cell has a first electric storage element having positive and negative electrodes, as well as a first covering film that, together with electrolyte, seals the first electric storage element.

The second electric storage cell has a second electric storage element having positive and negative electrodes, as well as a second covering film that, together with electrolyte, seals the second electric storage element, wherein the second electric storage cell is stacked with the first electric storage cell either directly or indirectly.

The frame forms a housing space in which the first electric storage cell and second electric storage cell are housed.

The first plate is made of metal and attached to the frame.

The second plate is made of metal and attached to the frame, and together with the first plate, sandwiches the first electric storage cell and second electric storage cell.

The electric storage unit may further comprise a cooling jacket that contacts the first plate or second plate.

According to this constitution, the cooling jacket forcibly cools the first plate or second plate or both, which allows the heat discharge effect of the electric storage module to improve further.

The frame has a positive electrode terminal and negative electrode terminal that are electrically connected to the first electric storage cell and second electric storage cell, the positive electrode terminal and negative electrode terminal may be placed symmetrically on one face of the frame, and the electric storage unit may further comprise a connection member that connects the positive electrode terminal or negative electrode terminal of one of the electric storage modules with the positive electrode terminal or negative electrode terminal of another of the electric storage modules.

Any discussion of problems and solutions involved in the related art has been included in this disclosure solely for the purposes of providing a context for the present invention, and should not be taken as an admission that any or all of the discussion were known at the time the invention was made.

According to the present invention described above, an electric storage module suitable for unitization and demonstrating excellent heat discharge property, as well as an electric storage unit, can be provided.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a perspective view of an electric storage module pertaining to an embodiment of the present invention.

FIG. 2 is an exploded perspective view of the same electric storage module.

FIG. 3 is a perspective view of the electric storage cell of the same electric storage module.

FIG. 4 is a section view of an electric storage cell of the same electric storage module.

FIG. 5 is a schematic view showing the terminal layouts of the same electric storage modules.

FIG. 6 is a perspective view of an electric storage unit pertaining to an embodiment of the present invention.

FIG. 7 is a perspective view of an electric storage unit pertaining to an embodiment of the present invention.

FIG. 8 is a perspective view of an electric storage unit pertaining to an embodiment of the present invention.

FIG. 9 is a perspective view of an electric storage unit pertaining to an embodiment of the present invention.

FIG. 10 is a perspective view of an electric storage unit pertaining to an embodiment of the present invention.

FIG. 11 is a perspective view of an electric storage unit pertaining to an embodiment of the present invention.

### DESCRIPTION OF THE SYMBOLS

10—Electric storage module

11—Frame

12—Electric storage cell

16—First plate

17—Second plate

18—First heat transmission insulation sheet

19—Second heat transmission insulation sheet

100, 200, 300, 400, 500, 600—Electric storage unit

110, 210, 310, 410, 520, 620—Connection member

510—Water-cooling jacket

610—Air-cooling jacket

### DETAILED DESCRIPTION OF EMBODIMENTS

Electric storage modules pertaining to embodiments of the present invention are explained.

### Constitution of Electric Storage Module

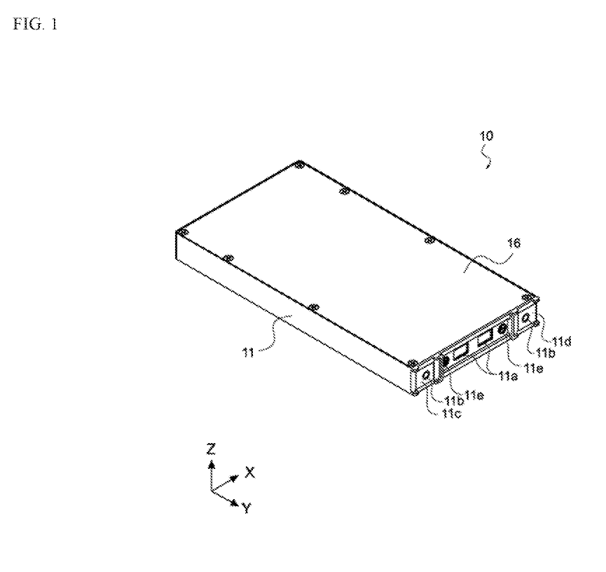

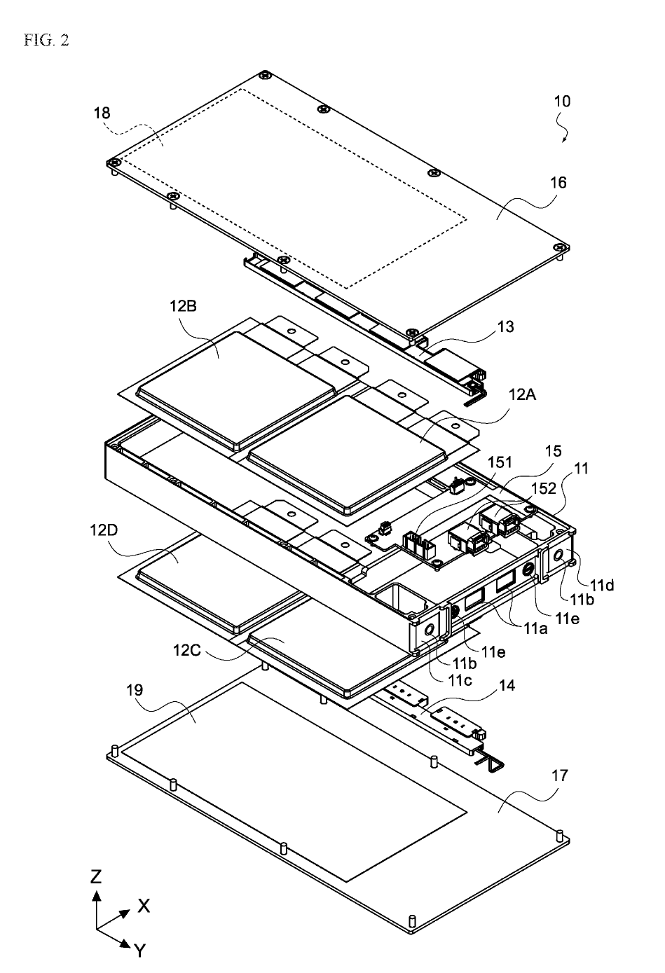

FIG. 1 is a perspective view of an electric storage module 10 pertaining to this embodiment, while FIG. 2 is an exploded perspective view of the electric storage module 10. It should be noted that, in the following drawings, the three directions of X, Y and Z intersect at right angles.

As shown in FIG. 1 and FIG. 2, the electric storage module 10 has a frame 11, electric storage cells 12 (12A to 12D), a first voltage detection board 13, second voltage detection board 14, connector board 15, first plate 16, second plate 17, first heat transmission insulation sheet 18, and second heat transmission insulation sheet 19. The electric storage module 10 has four electric storage cells 12, where the respective electric storage cells 12 are referred to as electric storage cells 12A, 12B, 12C, and 12D.

The frame 11 is a hollow frame-shaped member and forms a space for housing the electric storage cells 12. Provided on one face of the frame 11 are connector holes 11a, screw holes 11b, positive electrode terminal 11c, negative electrode terminal 11d, and polarity markings 11e. Two connector holes 11a are provided in the frame 11, but one hole or three or more holes may be provided.

Two screw holes 11b are provided in the frame 11, and the positive electrode terminal 11c and negative electrode terminal 11d are provided around the screw holes 11b, respectively. The polarity markings 11e, each provided near the positive electrode terminal 11c or negative electrode terminal 11d, are markings that indicate the polarities (+ or −) of the positive electrode terminal 11c and negative electrode terminal 11d.

The frame 11 is formed by insert molding, and is constituted in such a way that a bus bar made of metal material is buried in a resin member made of synthetic resin. The bus bar is electrically connected to the electric storage cells 12, while at the same time it is exposed around the screw holes 11b to form the positive electrode terminal 11c and negative electrode terminal 11d.

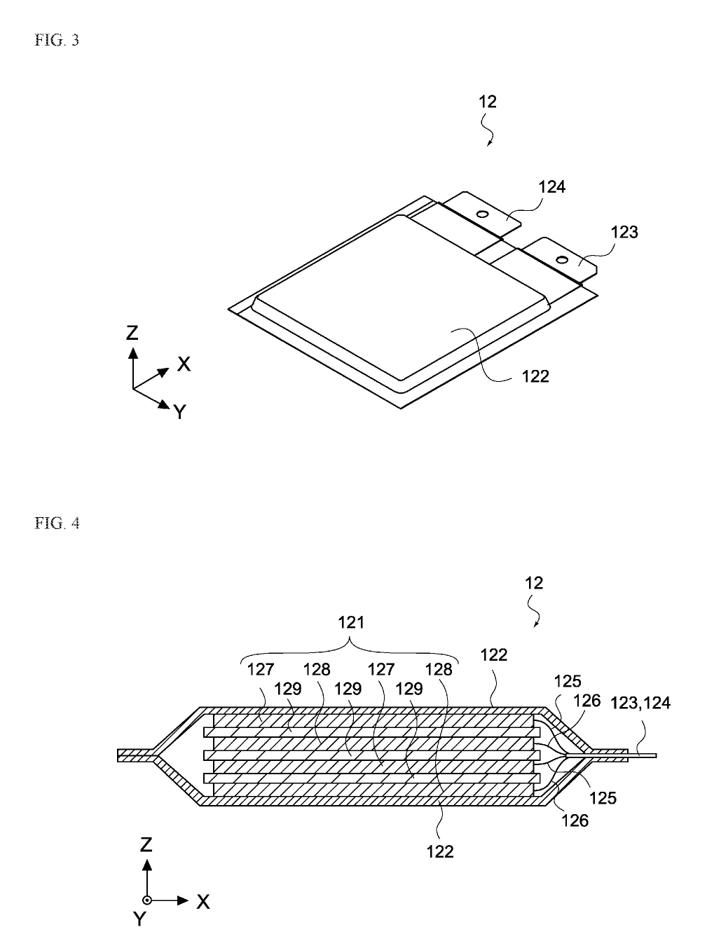

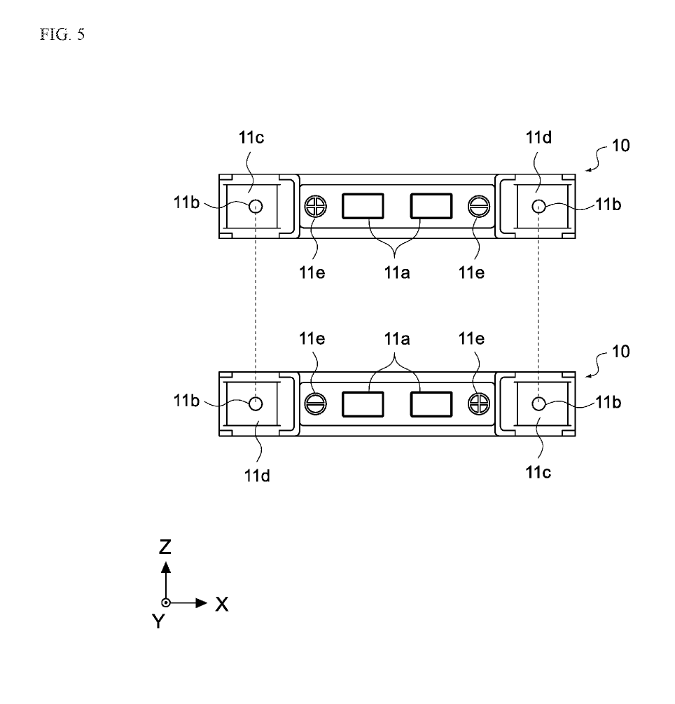

The electric storage cells 12 (12A to 12D) are cells capable of storing and discharging electricity, in the form of lithium ion capacitors, electric double-layer capacitors, lithium ion secondary batteries, etc. FIG. 3 is a perspective view of the electric storage cell 12, while FIG. 4 is a section view of the electric storage cell 12.

As shown in these figures, the electric storage cell 12 has an electric storage element 121, covering film 122, positive electrode tab 123, negative electrode tab 124, positive electrode conductor 125, and negative electrode conductor 126.

The electric storage element 121 is constituted by positive electrodes 127, negative electrodes 128 and separators 129, where the positive electrodes 127 and negative electrodes 128 are stacked alternately with the separators 129 placed in between.

The positive electrode 127 may be constituted by a positive electrode power collector made of metal and containing positive electrode active material, with positive electrode active material laminated on the top face and bottom face of the power collector. The positive electrode active material is active carbon, for example, and may be changed as deemed appropriate according to the type of electric storage cell 12.

The negative electrode 128 may be constituted by a negative electrode power collector made of metal and containing negative electrode active material, with negative electrode active material laminated on the top face and bottom face of the power collector. The negative electrode active material is carbon material, for example, and may be changed as deemed appropriate according to the type of electric storage cell 12.

The separator 129 is placed between the positive electrode 127 and negative electrode 128 to let electrolyte pass through, while preventing contact between (insulating) the positive electrode 127 and negative electrode 128. The separator 129 may be woven fabric, non-woven fabric, or synthetic resin microporous film, etc., for which cellulose or polyolefin material can be used.

The number of positive electrode 127 and negative electrode 128 layers constituting the electric storage element 121 is not limited in any way, so long as the constitution is such that the positive electrodes 127 and negative electrodes 128 are stacked alternately with the separators 129 placed in between.

The electric storage element 121 is sealed by the covering film 122 together with electrolyte. The electrolyte is not limited in any way, and may be changed as deemed appropriate according to the type of electric storage cell 12. The covering film 122 may be a laminate film constituted by metal foil with synthetic resin laminated on the top and bottom of it, and two covering films 122 are fused at the periphery of the electric storage element 121 to seal the interior.

Sandwiched between the covering films 122 are the positive electrode tab 123 and negative electrode tab 124 that are placed apart from each other. The positive electrode tab 123 continues electrically to the positive electrode 127 by way of the positive electrode conductor 125 being wiring or foil, while the negative electrode tab 124 continues electrically to the negative electrode 128 by way of the negative electrode conductor 126 being wiring or foil.

The positive electrode tab 123 and negative electrode tab 124 of each electric storage cell 12 are electrically connected to the positive electrode terminal 11c and negative electrode terminal 11d via the bus bar embedded in the frame 11.

As shown in FIG. 2, the electric storage cells 12 on the first plate 16 side (12A and 12B) and electric storage cells 12 on the second plate 17 side (12C and 12D) are stacked on top of each other in the Z direction and housed in the electric storage module 10 accordingly. It should be noted that the electric storage cells 12 may be stacked on top of each other directly, or indirectly via a heat discharging member. The electric storage module 10 may have four electric storage cells 12, but it is not limited thereto and may have one or multiple pairs of two electric storage cells 12 that are stacked on top of each other in the Z direction. In other words, the electric storage module 10 may have an even number of electric storage cells 12.

The first voltage detection board 13 monitors the voltages of the electric storage cells 12 on the first plate 16 side (12A and 12B). The first voltage detection board 13 is fixed to the frame 11 and electrically connected to the positive electrode tabs 123 and negative electrode tabs 124 of the electric storage cells 12A and 12B.

The second voltage detection board 14 monitors the voltages of the electric storage cells 12 on the second plate 17 side (12C and 12D). The second voltage detection board 14 is fixed to the frame 11 and electrically connected to the positive electrode tabs 123 and negative electrode tabs 124 of the electric storage cells 12C and 12D.

The connector board 15 has a connector 151, connectors 152, and a signal processing circuit, etc. The connector 151 is connected via wirings to the first voltage detection board 13 and second voltage detection board 14, and voltage detected by each electric storage cell 12 is input to it. The connectors 152 are inserted into the connector holes 11a, and external equipment for inspection are connected to them.

The first plate 16 is a plate-shaped member made of metal material such as aluminum, and joined to the frame 11. The first plate 16 may be fastened onto the frame 11 using screws, but it may also be joined to the frame 11 by other fixing method.

The second plate 17 is a plate-shaped member made of metal material such as aluminum, and joined to the frame 11. The second plate 17 may be fastened onto the frame 11 using screws, but it may also be joined to the frame 11 by another fixing method.

The first heat transmission insulation sheet 18 is a sheet-shaped member attached to the first plate 16, and made of material exhibiting properties of high heat conductivity and electrical insulation. Once the first plate 16 is fixed to the frame 11, the first heat transmission insulation sheet 18 is sandwiched between the electric storage cells 12 on the first plate 16 side (12A and 12B) and the first plate 16 and transmits the heat from these electric storage cells 12 to the first plate 16.

The second heat transmission insulation sheet 19 is a sheet-shaped member attached to the second plate 17, and made of material exhibiting properties of high heat conductivity and electrical insulation. Once the second plate 17 is fixed to the frame 11, the second heat transmission insulation sheet 19 is sandwiched between the electric storage cells 12 on the second plate 17 side (12C and 12D) and the second plate 17 and transmits the heat from these electric storage cells 12 to the second plate 17.

The electric storage module 10 has the constitution described above. Once each electric storage cell 12 is housed in the frame 11 and the first plate 16 and second plate 17 are joined to the frame 11, the first heat transmission insulation sheet 18, electric storage cells 12, and second heat transmission insulation sheet 19 are sandwiched between the first plate 16 and second plate 17. The electric storage cell 12A and electric storage cell 12C are pressed to each other, while the electric storage cell 12B and electric storage cell 12D are pressed to each other.

This way, the heat generated by the electric storage cell 12A and electric storage cell 12B is transmitted to the first plate 16 via the first heat transmission insulation sheet 18, and discharged. Also, the heat generated by the electric storage cell 12C and electric storage cell 12D is transmitted to the second plate 17 via the second heat transmission insulation sheet 19, and discharged. The first plate 16 and second plate 17 have high heat discharge effect because both are made of metal material.

Additionally, because each electric storage cell 12 is in contact with other electric storage cells 12 stacked in the Z direction, the temperature variation in each electric storage cell 12 can be reduced, or specifically the temperature variation can be kept to approx. 3° C. Furthermore, because it is structured in such a way that the frame 11 is sandwiched between the first plate 16 and second plate 17, the electric storage module 10 can be made thinner and is also structurally resistant to deflection and torsion.

### Terminal Layout

FIG. 5 is a schematic view showing two electric storage modules 10 that are oriented differently in the vertical direction. As shown in this figure, the positive electrode terminal 11c and negative electrode terminal 11d are placed symmetrically on one face of the electric storage module 10. Accordingly, orienting the electric storage module 10 upside down swaps the positions of the positive electrode terminal 11c and negative electrode terminal 11d while maintaining the positions of the screw holes 11b. This allows for unitization of electric storage modules 10 in various modes as described later.

### Electric Storage Unit

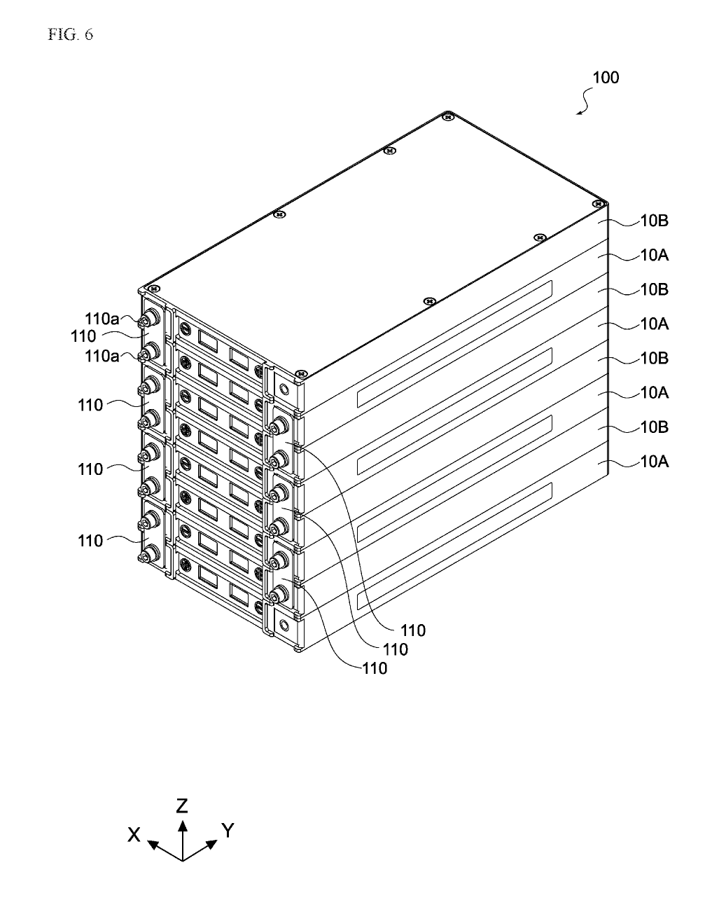

FIG. 6 is a schematic view of an electric storage unit 100 pertaining to an embodiment. As shown in this figure, the electric storage unit 100 is constituted by multiple electric storage modules 10 (10A and 10B) that are connected in the Z direction.

To be specific, the electric storage unit 100 is constituted in such a way that electric storage modules 10A oriented with their second plate 17 (refer to FIG. 2) facing down in the Z direction are stacked alternately with electric storage modules 10B oriented with their first plate 16 (refer to FIG. 2) facing down in the Z direction, with the adjacent pairs of electric storage modules 10A and electric storage modules 10B connected by multiple connection members 110.

Each connection member 110 is made of conductive material and connects two adjacent electric storage modules 10 using screws 110a inserted into the screw holes 11b, to electrically connect the positive electrode terminals 11c (refer to FIG. 1) and negative electrode terminals 11d (refer to FIG. 1) of both electric storage modules 10.

As described above, each electric storage module 10 has its positive electrode terminal 11c connected to the negative electrode terminal 11d of one adjacent electric storage module 10, and its negative electrode terminal 11d connected to the positive electrode terminal 11c of the other adjacent electric storage module 10, by the connection members 110. This way, the electric storage modules 10 are connected in series.

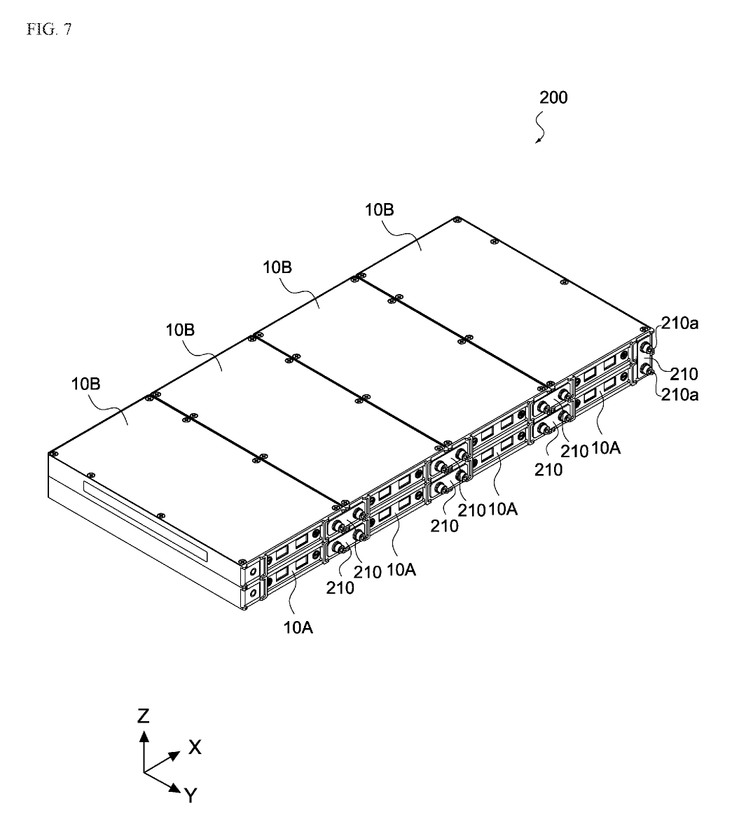

FIG. 7 is a schematic view of another electric storage unit 200 pertaining to an embodiment. As shown in this figure, the electric storage unit 200 is constituted by multiple electric storage modules 10 (10A and 10B) that are connected in the X direction and Z direction.

To be specific, the electric storage unit 200 is constituted in such a way that an electric storage module 10A row in which electric storage modules 10A are arranged in the X direction is stacked in the Z direction with an electric storage module 10B row in which electric storage modules 10B are arranged in the X direction, with the adjacent electric storage modules 10 connected by multiple connection members 210.

Each connection member 210 is made of conductive material and connects two adjacent electric storage modules 10 using screws 210a inserted into the screw holes 11b, to electrically connect the positive electrode terminals 11c and negative electrode terminals 11d of both electric storage modules 10.

As described above, each electric storage module 10 has its positive electrode terminal 11c which is connected to the negative electrode terminal 11d of one adjacent electric storage module 10, and its negative electrode terminal 11d which is connected to the positive electrode terminal 11c of another adjacent electric storage module 10 on the opposite side, by the connection members 210. This way, the electric storage modules 10 are connected in series.

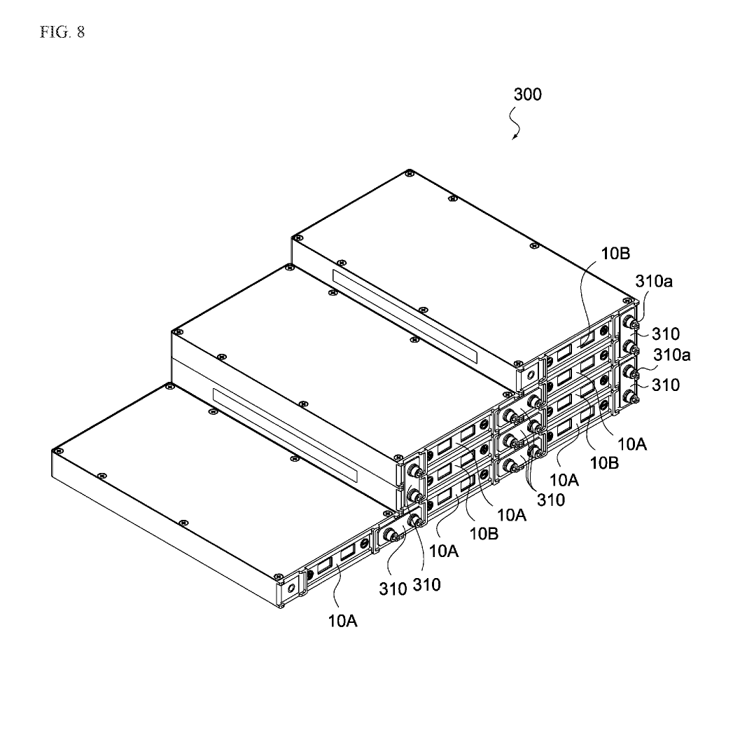

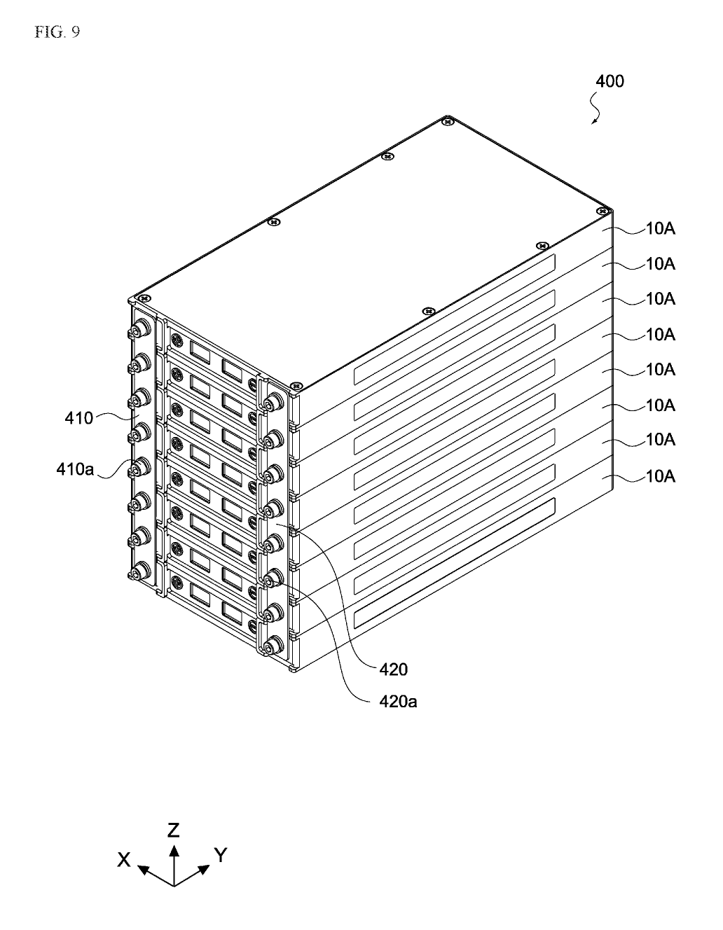

FIG. 8 is a schematic view of another electric storage unit 300 pertaining to an embodiment. As shown in this figure, the electric storage unit 300 is constituted by multiple electric storage modules 10 (10A and 10B) that are connected in the X direction and Z direction.

To be specific, the electric storage unit 300 is constituted in such a way that electric storage module 10A rows in which electric storage modules 10A are arranged in the X direction are stacked alternately in the Z direction with electric storage module 10B rows in which electric storage modules 10B are arranged in the X direction, with the adjacent electric storage modules 10 connected by multiple connection members 310.

Each connection member 310 is made of conductive material and connects two adjacent electric storage modules 10 using screws 310a inserted into the screw holes 11b, to electrically connect the positive electrode terminals 11c and negative electrode terminals 11d of both electric storage modules 10.

As described above, each electric storage module 10 has its positive electrode terminal 11c which is connected to the negative electrode terminal 11d of one adjacent electric storage module 10, and its negative electrode terminal 11d which is connected to the positive electrode terminal 11c of another adjacent electric storage module 10 on the opposite side, by the connection members 310. This way, the electric storage modules 10 are connected in series.

FIG. 9 is a schematic view of another electric storage unit 400 pertaining to an embodiment. As shown in this figure, the electric storage unit 400 is constituted by multiple electric storage modules 10 (10A) that are connected in the Z direction.

To be specific, the electric storage unit 400 is constituted in such a way that electric storage modules 10A oriented with their second plate 17 (refer to FIG. 2) facing down in the Z direction are stacked in the Z direction, with the adjacent electric storage modules 10A connected by a connection member 410 and connection member 420.

The connection member 410 is made of conductive material and connects the electric storage modules 10 using screws 410a inserted into the screw holes 11b, to electrically connect the positive electrode terminals 11c of the electric storage modules 10.

The connection member 420 is made of conductive material and connects the electric storage modules 10 using screws 420a inserted into the screw holes 11b, to electrically connect the negative electrode terminals 11d of the electric storage modules 10.

As described above, each electric storage module 10 has its positive electrode terminal 11c which is connected to the positive electrode terminal 11c of another electric storage module 10 by the connection member 410, and its negative electrode terminal 11d which is connected to the negative electrode terminal 11d of another electric storage module 10 by the connection member 420. This way, the electric storage modules 10 are connected in parallel.

### Cooling Jacket

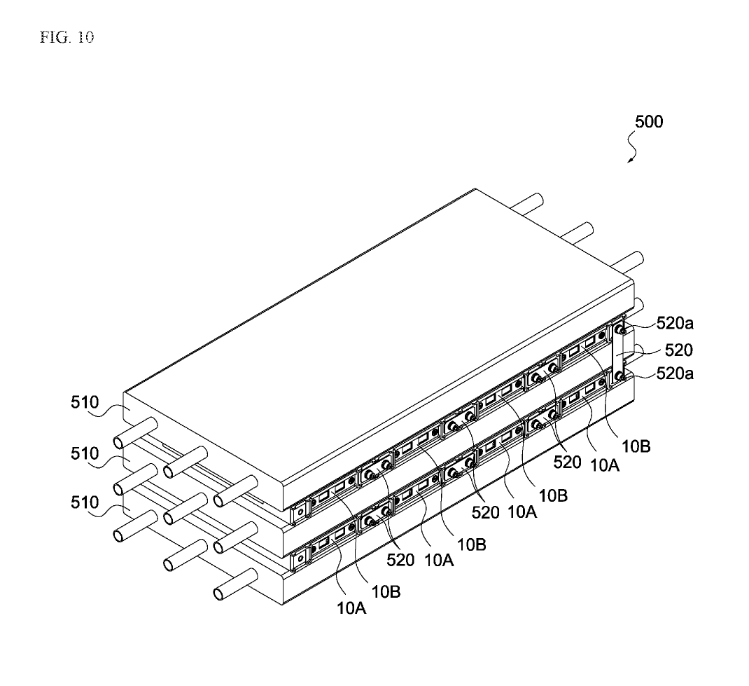

Electric storage modules 10 pertaining to an embodiment can constitute an electric storage unit along with a cooling jacket. FIG. 10 is a perspective view of an electric storage unit 500 having water-cooling jackets.

As shown in this figure, the electric storage unit 500 has electric storage modules 10 (10A and 10B) and water-cooling jackets 510. To be specific, the electric storage unit 500 is constituted in such a way that an electric storage module 10A row in which electric storage modules 10A are arranged in the X direction, and an electric storage module 10B row in which electric storage modules 10B are arranged in the X direction, are sandwiched by three water-cooling jackets 510. The electric storage modules 10 are connected to each other by connection members 520.

The connection member 520 is made of conductive material and connects two adjacent electric storage modules 10 using screws 520a inserted into the screw holes 11b, to electrically connect the positive electrode terminals 11c and negative electrode terminals 11d of both electric storage modules 10.

The water-cooling jacket 510 is constituted in such a way that cooling water or other refrigerant flows inside it, and the water-cooling jacket contacts the first plate 16 and second plate 17 of the electric storage module 10 to cool the plates. Because the water-cooling jacket 510 forcibly cools the first plate 16 and second plate 17, the electric storage unit 500 can achieve even higher cooling effect. It should be noted that the number of water-cooling jackets 510 is not limited to three, so long as the constitution is such that a water-cooling jacket contacts the first plate 16 or second plate 17 of at least one electric storage module 10.

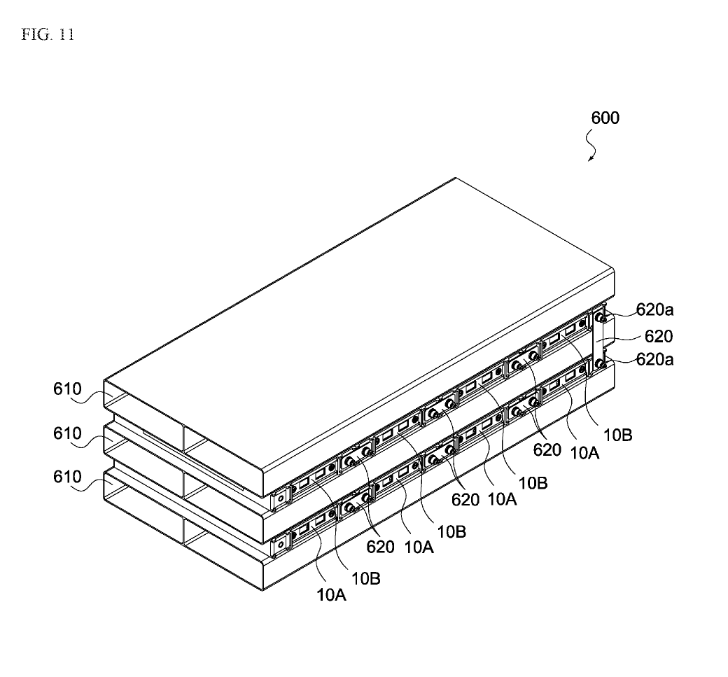

Also, FIG. 11 is a perspective view of an electric storage unit 600 having air-cooling jackets. As shown in this figure, the electric storage unit 600 has electric storage modules 10 (10A and 10B) and air-cooling jackets 610. To be specific, the electric storage unit 600 is constituted in such a way that an electric storage module 10A row in which electric storage modules 10A are arranged in the X direction, and an electric storage module 10B row in which electric storage modules 10B are arranged in the X direction, are sandwiched by three air-cooling jackets 610. The electric storage modules 10 are connected to each other by connection members 620.

The connection member 620 is made of conductive material and connects two adjacent electric storage modules 10 using screws 620a inserted into the screw holes 11b, to electrically connect the positive electrode terminals 11c and negative electrode terminals 11d of both electric storage modules 10.

The air-cooling jacket 610 is constituted in such a way that air flows inside it, and the air-cooling jacket contacts the first plate 16 and second plate 17 of the electric storage module 10 to cool the plates. Because the air-cooling jacket 610 forcibly cools the first plate 16 and second plate 17, the electric storage unit 600 can achieve even higher cooling effect. It should be noted that the number of air-cooling jackets 610 is not limited to three, so long as the constitution is such that an air-cooling jacket contacts the first plate 16 or second plate 17 of at least one electric storage module 10.

The constitution of the electric storage unit is not limited to the foregoing, and electric storage modules 10 may be unitized into an electric storage unit in any desired mode. The layout of cooling jackets such as water-cooling jackets and air-cooling jackets is not limited to the foregoing, either.

### Example of Variation

While the forgoing described the frame 11 as having two screw holes 11b, a male screw protruding from the frame 11 may be provided instead of the screw hole 11b. Also the frame 11 may have one each of screw hole and male screw provided in it.

In addition, while the foregoing described the electric storage module 10 as having a first heat transmission insulation sheet 18 and second heat transmission insulation sheet 19, it need not have these sheets. In this case, the first plate 16 and second plate 17 contact the electric storage cell 12 directly and heat is transmitted to the first plate 16 and second plate 17 via the electric storage cell 12.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, “a” may refer to a species or a genus including multiple species, and “the invention” or “the present invention” may refer to at least one of the embodiments or aspects explicitly, necessarily, or inherently disclosed herein. The terms “constituted by” and “having” refer independently to “typically or broadly comprising”, “comprising”, “consisting essentially of”, or “consisting of” in some embodiments. In this disclosure, any defined meanings do not necessarily exclude ordinary and customary meanings in some embodiments.

The present application claims priority to Japanese Patent Application No. 2015-195932, filed Oct. 1, 2015, the disclosure of which is incorporated herein by reference in its entirety including any and all particular combinations of the features disclosed therein.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. An electric storage module comprising:
a first electric storage cell with a first electric storage element that has positive and negative electrodes, as well as a first covering film that, together with electrolyte, seals the first electric storage element;
a second electric storage cell with a second electric storage element that has positive and negative electrodes, as well as a second covering film that, together with electrolyte, seals the second electric storage element, wherein the second electric storage cell is stacked with the first electric storage cell either directly or indirectly;
a frame that forms a housing space in which the first electric storage cell and second electric storage cell are housed;
a first plate made of metal and attached to the frame; and
a second plate made of metal and attached to the frame, which, together with the first plate, sandwiches the first electric storage cell and second electric storage cell.

2. An electric storage module according to claim 1, further comprising:
a first heat transmission member which is placed between the first electric storage cell and first plate and contacts the first electric storage cell and first plate; and
a second heat transmission member which is placed between the second electric storage cell and second plate and contacts the second electric storage cell and second plate.

3. An electric storage module according to claim 1, wherein:
the frame has a positive electrode terminal and negative electrode terminal that are electrically connected to the first electric storage cell and second electric storage cell; and
the positive electrode terminal and negative electrode terminal are placed symmetrically on one face of the frame.

4. An electric storage module according to claim 2, wherein:
the frame has a positive electrode terminal and negative electrode terminal that are electrically connected to the first electric storage cell and second electric storage cell; and
the positive electrode terminal and negative electrode terminal are placed symmetrically on one face of the frame.

5. An electric storage unit constituted by multiple electric storage modules that are attached together and each comprising:
a first electric storage cell with a first electric storage element that has positive and negative electrodes, as well as a first covering film that, together with electrolyte, seals the first electric storage element;
a second electric storage cell with a second electric storage element that has positive and negative electrodes, as well as a second covering film that, together with electrolyte, seals the second electric storage element, wherein the second electric storage cell is stacked with the first electric storage cell either directly or indirectly;
a frame that forms a housing space in which the first electric storage cell and second electric storage cell are housed;
a first plate made of metal and attached to the frame; and
a second plate made of metal and attached to the frame, which, together with the first plate, sandwiches the first electric storage cell and second electric storage cell.

6. An electric storage unit according to claim 5, further comprising:
a cooling jacket which is placed between the multiple electric storage modules and contacts the first plate or second plate.

7. An electric storage unit according to claim 5, wherein:
the frame has a positive electrode terminal and negative electrode terminal that are electrically connected to the first electric storage cell and second electric storage cell, and the positive electrode terminal and negative electrode terminal are placed symmetrically on one face of the frame; and
the electric storage unit further comprises connection members that connect the positive electrode terminal or negative electrode terminal of one electric storage module and the positive electrical terminal or negative electrode terminal of another electric storage module.
